(19) United States
(12) Patent Application Publication
(10) Pub. No.: US 2013/0272936 A1
(43) Pub. Date: Oct. 17, 2013

(54) Brominated Inorganic Sorbents For Reduction of Mercury Emissions

(71) Applicants: Christopher J. Nalepa, Zachary, LA (US); Qunhui Zhou, Baton Rouge, LA (US); Charles Vadovic, League City, TX (US); Gregory H. Lambeth, Baton Rouge, LA (US)

(72) Inventors: Christopher J. Nalepa, Zachary, LA (US); Qunhui Zhou, Baton Rouge, LA (US); Charles Vadovic, League City, TX (US); Gregory H. Lambeth, Baton Rouge, LA (US)

(21) Appl. No.: 13/988,166

(22) PCT Filed: Nov. 14, 2011
(86) PCT No.: PCT/US11/60605

§ 371 Date: Jun. 24, 2013

Related U.S. Application Data
(60) Provisional application No. 61/416,077, filed on Nov. 22, 2010.

(51) Int. Cl. B01D 53/64

(52) U.S. Cl. CPC B01D 53/64
USPC 423/210; 252/184

(57) ABSTRACT

This invention provides brominated sorbent compositions which are brominated inorganic sorbents having about 0.5 wt % to about 20 wt % bromine therein, based on the total weight of the brominated inorganic sorbent. Methods for preparing brominated sorbent compositions are also provided, as are methods for reducing mercury emissions employing brominated sorbents. In the methods for preparing the brominated inorganic sorbents, the bromine source is elemental bromine and/or hydrogen bromide.

### TECHNICAL FIELD

This invention relates to reduction of mercury emissions from combustion gas streams.

### BACKGROUND

It is well known that mercury is both hazardous and poisonous. As a result, there is frequently a need to remove mercury from combustion gas streams from industrial processes, such as coal-fired power plants and cement plants. Capturing mercury from combustion gas streams is a difficult technical problem because the gas volumes are large, the concentrations of mercury in the gas are usually low, and the combustion gas stream temperatures are relatively high.

It is known that activated carbon can be injected into a gas stream containing mercury vapor. When mercury vapor contacts activated carbon particles, the mercury is captured and held by the activated carbon particles. The particles are then collected by a particulate collection device, such as an electrostatic precipitator or a baghouse filter. Brominated activated carbons, formed by treating activated carbon with either a bromide salt solution or Br₂ gas, are also known for mercury removal, and also capture and hold mercury. Low levels of bromination have been observed to increase the mercury-removal performance of activated carbon sorbents; see in this regard U.S. Pat. No. 6,953,494. In coal-fired power plants, the activated carbon is captured with the fly ash. However, the presence of activated carbon in the fly ash often renders such fly ash unsuitable for further use, e.g., as an ingredient in concrete.

Sorbents that are not carbon-based have been reported for use in emission reduction. U.S. Pat. No. 4,101,631 describes sulfur-containing aluminosilicate zeolites for mercury removal. Certain natural zeolites were used to remove various pollutants, including mercury, from exhaust gases in U.S. Pat. No. 5,695,110. Manganese oxides were used to remove NOₓ and SOₓ, and also remove mercury; see U.S. Pat. Nos. 6,579,509 and 6,974,565. Bromination of a modified ZSM-5 zeolite was reported in U.S. Pat. No. 4,748,013; the bromine therein is removed by water-washing or by exposure to temperatures of 60° C. or more.

Even though many mercury control techniques have already been developed, new ways to effectively and economically reduce mercury emissions are still needed.

### SUMMARY OF THE INVENTION

This invention provides sorbents which reduce mercury emissions from combustion gas streams, methods for preparing such sorbents, and methods for using such sorbents to reduce mercury emissions. The methods described herein employ elemental bromine and/or hydrogen bromide as the bromine source. Surprisingly, bromination of inorganic substrates is facile, and provides brominated sorbents that are quite effective for mercury removal from combustion gas streams. Several benefits are provided by the compositions and methods described herein. Brominated inorganic sorbents of this invention can be exposed to hotter temperatures than those to which carbon-based sorbents can be exposed (e.g., above about 1100° F., or about 593° C.). Additionally, since the brominated inorganic substrates of this invention are particulates, they can be removed from the gas stream by the same mechanisms employed to remove other particulates present in the combustion gas stream. A further advantage is that the brominated inorganic sorbents can be included in concrete.

Unexpectedly, for at least some of the inorganic substrates, treatment with a sulfur source permits a greater degree of bromination of the inorganic substrate than in the absence of the sulfur source. This is beneficial, as a greater amount of bromine in the sorbent generally provides greater mercury removal for the same amount of sorbent. Another advantage is that some inorganic substrates which normally do not absorb appreciable amounts of bromine will absorb bromine in amounts suitable to make them effective as mercury sorbents after treatment with a sulfur source.

An embodiment of this invention is a brominated sorbent composition. The composition is a brominated inorganic sorbent having about 0.5 wt % to about 20 wt % bromine therein, based on the total weight of the brominated inorganic sorbent. The brominated inorganic sorbent is formed from an inorganic substrate and a bromine source, which bromine source is
elemental bromine, with the proviso that
   when the bromine source is elemental bromine in solution or in a carrier gas, the inorganic substrate is other than a ZSM-5 zeolite with an SiO₂:Al₂O₃ ratio of about 70:1 or greater; and/or
hydrogen bromide, with the proviso that
   when the hydrogen bromide is an aqueous solution of hydrogen bromide, either the inorganic substrate or the brominated inorganic sorbent has been treated with a sulfur source, or the inorganic substrate is cement dust or an inorganic hydroxide.

Still another embodiment of this invention is a method of preparing a brominated sorbent. The method comprises contacting an inorganic substrate and a bromine source, which bromine source is elemental bromine and/or hydrogen bromide, to form a brominated inorganic sorbent. Optionally, a sulfur source and the inorganic substrate can be contacted, the sulfur source and the inorganic substrate being contacted before or during the contacting of the inorganic substrate and the bromine source.

Other embodiments of this invention include methods of reducing mercury emissions, which methods employ the brominated sorbents just described.

These and other embodiments and features of this invention will be still further apparent from the ensuing description and appended claims.

### FURTHER DETAILED DESCRIPTION OF THE INVENTION

Throughout this document, the term “particulates” refers to small particles (generally about 45 μm or less in diameter) suspended in the gas stream. The term “gas stream”, as used throughout this document, refers to a quantity of gas that is moving in a direction. As used throughout this document, the phrase “combustion gas” refers to the gas (mixture) resulting from combustion. Flue gas is a type of combustion gas. In this connection, the term “stream” as used in “combustion gas stream” refers to a quantity of combustion gas that is moving in a direction. The terms “brominated sorbent” and “brominated sorbents” as used throughout this document refer to brominated inorganic sorbents, including the brominated inorganic sorbents that have been treated with a sulfur source, unless otherwise noted.

The brominated sorbents of this invention are formed by treating a suitable substrate with an amount of a bromine source that is effective to increase the ability of the inorganic substrate to absorb mercury and/or mercury-containing compounds. More particularly, brominated inorganic sorbents are formed by contacting an inorganic substrate and a bromine source, which bromine source is elemental bromine and/or hydrogen bromide. Elemental bromine is a preferred bromine source. The bromine source can be gaseous, liquid, or, in some instances, in solution. Contacting an inorganic substrate and a bromine source significantly increases the ability of the brominated inorganic sorbent formed thereby to absorb mercury and mercury-containing compounds. Optionally, the inorganic substrate can be treated (contacted) with a sulfur source prior to or during the contacting with the bromine source. When the inorganic substrate is contacted with a sulfur source before contact with the bromine source, the product, prior to contact with the bromine source, is sometimes referred to as an “sulfur-treated inorganic substrate”.

Elemental bromine (Br₂) and/or hydrogen bromide (HBr) can be used in gaseous form or liquid form; in some instances, elemental bromine and/or hydrogen bromide can be in the form of aqueous solutions. Hydrogen bromide can be used as an aqueous solution either with an inorganic substrate and a sulfur source, or with cement dust or inorganic hydroxides, whether or not a sulfur source is employed with the cement dust or inorganic hydroxide. Elemental bromine can be used as an aqueous solution when the inorganic substrate is other than a ZSM-5 zeolite with an SiO₂:Al₂O₃ ratio of about 70:1 or greater. For the aqueous solutions, concentrations are generally about 0.1 wt % or more, usually in the range of about 0.1 wt % to about 10 wt %, and preferably in the range of about 0.5 wt % to about 5 wt %. Preferably, the elemental bromine and/or hydrogen bromide are in gaseous form when brought into contact with the inorganic substrate. Elemental bromine is a preferred bromine source for bromination of inorganic substrates. Mixtures of the two bromine sources can be employed; usually, such mixtures are in the same form (e.g., liquid, solution, or gas).

When the bromine source is gaseous Br₂ and/or gaseous HBr, use of undiluted Br₂(g) and/or HBr(g) is preferred, although a carrier gas can be used to transport the Br₂(g) and/or HBr(g). Typical carrier gases are inert, and include nitrogen and argon; air can also be employed as a carrier gas. Elemental bromine can be used in a carrier gas when the inorganic substrate is other than a ZSM-5 zeolite with an SiO₂:Al₂O₃ ratio of about 70:1 or greater.

Both Br₂ and HBr can used in liquid form. Elemental bromine is a liquid at room temperature, and can generally be used under ambient conditions. Alternatively, bromine can be used at elevated temperatures with increased pressure. Similarly, HBr can be liquefied by increasing the pressure. The inorganic substrate or sulfur-treated inorganic substrate is preferably contacted by adding the liquid bromine or hydrogen bromide to the inorganic substrate. Other ways to bring liquid Br₂ or HBr into contact with the inorganic substrate include adding both the liquid bromine or hydrogen bromide and the inorganic substrate to the same reaction zone at the same time. Precautions in handling and choice of equipment are recommended due to the corrosive and acidic nature of both Br₂ and HBr.

In one production method, Br₂(g) and/or HBr(g) can be injected into a sealed processing vessel containing the inorganic substrate with only a modest, temporary rise in vessel pressure, which pressure subsides as the gas species become incorporated into the inorganic substrate, with or without agitation of the vessel and/or its contents. When the gas contacts the inorganic substrate, it is usually quickly adsorbed. In some embodiments, this contacting occurs at an elevated temperature, with the inorganic substrate at least as hot as the bromine-containing gas; preferably the inorganic substrate is at a temperature at or above about 60° C. during the contacting at elevated temperatures. Suitable temperatures during the contacting are in the range from ambient temperature to about 175° C.; preferred temperatures during the contacting are in the range of about 60° C. to about 150° C.

In another method for contacting elemental bromine and an inorganic substrate, the proper amount of liquid bromine is measured out, and under a nitrogen purge, the Br₂ is fed into the reaction zone, where the bromine vaporizes. Another way of contacting Br₂ and an inorganic substrate is to place the inorganic substrate in a vessel, add liquid bromine in an open container within the vessel, and seal the vessel for a period of time, typically about an hour to overnight. A preferred open container is a narrow tube (e.g., a capillary tube on the laboratory scale). Optionally, the sealed vessel can be heated for at least a portion of the time the vessel is sealed; temperatures are generally about 60° C., preferably about 60° C. to about 100° C., more preferably about 80° C. to about 100° C. Heating of the sealed vessel should be performed so that the pressure does not increase enough to break the seal. To employ these methods when HBr (or both HBr and Br₂) is the bromine source, the use of elevated pressure and/or low temperatures is needed.

A number of types of inorganic substrates can be used in the practice of this invention, including porous inorganic oxides, natural zeolites, synthetic zeolites, clay minerals, inorganic hydroxides, mixed metal oxides, fluid catalytic cracking (FCC) catalysts, hydroprocessing catalysts, other metallated porous substrates, and the like can be used in the practice of this invention. Activated carbon, fly ash, and charcoal are not considered to be inorganic substrates in the context of this invention. Calcium-based inorganic substrates, such as lime and limestone and calcium salts, are not included as inorganic substrates.

Suitable inorganic substrates include porous inorganic oxides such as magnesia and titania; natural zeolites, such as chabazite, clinoptilolite, and faujasite; synthetic zeolites, such as synthetic chabazite, zeolites with high Si:Al ratios (ZSM-5, beta zeolites, sodalite), zeolites with moderate Si:Al ratios (Y zeolites, A zeolites), silica alumina phosphate (SAPO) zeolites, ion exchanged zeolites, uncalcined zeolites, including ACZeo S-010 (an uncalcined catalyst precursor of ACZeo S 100, a SAPO zeolite; see International Publication WO 2010/142448 A2 for additional details); clay minerals such as kaolin, kaolinite, bentonite, and montmorillonite; inorganic hydroxides such as iron hydroxide; mixed metal oxides such as hydrotalcites and metallated double layered clays; diatomaceous earth; cement dust (also called cement kiln dust, or CKD); FCC catalysts such as those containing zeolites and modified zeolites, amorphous and crystalline alumina, metal trapping agents, and/or clays and other inorganic materials; hydroprocessing catalysts including those on porous substrates such as alumina, silica, or titania, metallated with one or more transition metals such as molybdenum, tungsten, iron, cobalt, nickel, palladium, platinum, and other metallated porous substrates; kitty litter; and combinations of any two or more of the foregoing. Preferred inorganic substrates include natural zeolites and uncalcined zeolites, especially natural chabazite, natural clinoptilolite, and ACZeo S-010.

Although the size of the inorganic substrate particles is not critical, typical average particle sizes for the inorganic substrates are in the range of about 1 μm to about 50 μm, preferably in the range of about 3 μm to about 20 μm. If the particles are larger than desired, their size can be reduced by usual methods, such as grinding or milling. For the inorganic substrates, particle size reduction can occur before the bromination step, during the bromination step (in the presence of the elemental bromine and/or hydrogen bromide), or when an optional treatment step with a sulfur source is performed, the particle size reduction can occur before or during the sulfur treatment step.

Treatment of the inorganic substrate with the bromine source is generally conducted such that the sorbent has about 0.1 wt % to about 20 wt % bromine, based on the weight of the brominated inorganic sorbent after contact with the bromine source. Preferably the brominated inorganic sorbent has about 0.5 wt % to about 15 wt % bromine, more preferably about 3 wt % to about 10 wt % bromine based on the weight of the brominated inorganic sorbent. Amounts of bromine greater than 20 wt % can be incorporated into the inorganic substrate if desired. However, as the amount of bromine in the sorbent increases, there is a greater possibility that some of the bromine may evolve from the sorbent under some circumstances.

To achieve the desired amount of bromine in the brominated sorbent, an amount of the bromine source that contains the appropriate amount of bromine is combined with the inorganic substrate. For example, to form a brominated inorganic sorbent having 5 wt % bromine, the weight of the bromine source and the weight of the inorganic substrate are added together; when the amount of bromine in the bromine source is 5% of the total weight, a brominated inorganic sorbent having about 5 wt % bromine is formed, since all of the bromine in the bromine source is usually incorporated into the brominated inorganic sorbent. When an optional treatment with a sulfur source is performed, the amount of bromine in the brominated inorganic sorbent is as just described, except that the amount of bromine is based upon the total weight of the brominated, sulfur-treated inorganic sorbent.

Optionally, the inorganic substrate can be contacted with a sulfur source. The sulfur source and the inorganic substrate are normally and preferably contacted before the inorganic substrate and the bromine source are contacted. The sulfur source and the bromine source can contact the inorganic substrate at the same time; preferably, this occurs when the sulfur source and the bromine source are in the same form (e.g., both in solution). The term “sulfur source” as used throughout this document means elemental sulfur and/or one or more sulfur compounds. Similarly, as used throughout this document, the term “sulfur treatment” means treatment with a sulfur source.

Suitable sulfur sources include elemental sulfur (α, β, γ, and amorphous forms), and sulfur compounds such as carbon disulfide, and salts of sulfur-containing ions (sulfur salts), including thiosulfate, pyrosulfite, pyrosulfate, sulfite, hydrogen sulfite, sulfate, hydrogen sulfate, sulfide, and the like. The counterions of the sulfur salts can be cations of alkali metals (e.g., lithium, sodium, potassium, cesium), alkaline earth metals (e.g., magnesium, calcium, barium), ammonium, and zinc. The sulfur sources can be anhydrous or hydrated; anhydrous sulfur sources are not necessary in the practice of this invention. Preferred sulfur sources include elemental sulfur and salts of sulfur-containing ions. A preferred sulfur-containing ion is thiosulfate; a preferred thiosulfate is sodium thiosulfate. Sulfur halides such as sulfur dibromide and sulfur chlorides are not employed as sulfur sources in the practice of this invention.

The sulfur compounds usually can be used in solid form or in solution; carbon disulfide is conveniently used in liquid form, or in gaseous form due to its relatively low boiling point. Solutions are generally aqueous solutions. Concentrations of sulfur-containing solutions are typically about 0.2 wt % or more, usually in the range of about 0.2 wt % to about 10 wt %, and preferably in the range of about 0.5 wt % to about 5 wt %. Mixtures of two or more sulfur sources can be used; usually, such mixtures are in the same form (e.g., solid or solution). Preferred sulfur sources include elemental sulfur.

Optional treatment of the inorganic substrate with a sulfur source is typically conducted such that the sulfur-treated inorganic substrate has about 0.1 wt % to about 15 wt % sulfur, based on the weight of the sulfur-treated inorganic sorbent. Preferably the sulfur-treated inorganic sorbent has about 0.5 wt % to about 10 wt % sulfur, more preferably about 1 wt % to about 5 wt % sulfur, based on the weight of the sulfur-treated inorganic sorbent (i.e., before bromination of the sulfur-treated inorganic sorbent).

To achieve the desired amount of sulfur in the inorganic substrate, an amount of the sulfur source that contains the appropriate amount of sulfur is combined with the inorganic substrate. For example, to form a sulfur-treated inorganic substrate having 5 wt % sulfur, the weight of the sulfur source and the weight of the inorganic substrate are added together; when the amount of sulfur in the sulfur source is 5% of the total weight, a sulfur-treated inorganic substrate having about 5 wt % sulfur is formed, since all of the sulfur from the sulfur source is usually incorporated into the sulfur-treated inorganic substrate.

If the inorganic substrate begins at ambient temperature, preferably it is preheated, usually to a temperature above about 100° C. One purpose of such preheating is to drive off any physically-adsorbed moisture from the inorganic substrate which blocks the inorganic substrate's pores and may interfere with the sulfur treatment step. Preferably, such heating is performed before treatment with the sulfur source. The inorganic substrate can be treated with the sulfur source without drying, if desired.

For contacting a solid sulfur source and an inorganic substrate, standard dry blending techniques can be used. Such techniques include stirring, tumbling, and the like. Another method is to grind or mill the solids while mixing them together. The equipment used to contact inorganic substrates with solid sulfur sources can be, for example, a stationary mixer, a rotating drum, a transport reactor, or any other contactor suitable for blending solid ingredients. Any equipment or method that quickly and evenly distributes the sulfur source to intimately contact the inorganic substrate is acceptable.

When the sulfur source is in solution, the solution is normally brought into contact with the inorganic substrate by spraying or by impregnation (incipient wetness). After spray application, the solvent is removed, usually by heating, or by passing a stream of air or an inert gas over or through the sulfur-treated inorganic substrate. In an impregnation treatment, the inorganic substrate is placed in the solution of the sulfur source, and the mixture is stirred for a period of time, usually a few minutes on the laboratory scale. The solvent is removed from the sulfur-treated inorganic substrate, typically via filtration; other solid/liquid separation techniques such as centrifugation can be employed. If desired, further solvent removal may be effected by heating, or by passing a stream of air or an inert gas over or through the sulfur-treated inorganic substrate. If the sulfur-treated inorganic substrate clumps together, it should be de-clumped. Sometimes, a further step of heating the sulfur-treated inorganic substrate in an inert atmosphere is performed.

When an inorganic substrate undergoes optional treatment with a sulfur source, the sulfur-treated inorganic substrate is preferably subjected to another step after the sulfur treatment. This step can be accomplished by various methods, including applying vacuum to the vessel holding the sulfur-treated inorganic sorbent, purging the vessel with air or an inert gas, and/or heating the sulfur-treated inorganic sorbent to a temperature above the temperature at which the treatment with the sulfur source was conducted. Preferably, this is accomplished by heating the sulfur-treated inorganic sorbent, normally to one or more temperatures of about 40° C. or more, typically in the range of about 40° C. to about 250° C., and preferably in the range of about 100° C. to about 200° C.

For the bromination, if the inorganic substrate begins at ambient temperature, preferably it is preheated, usually to a temperature of above about 100° C. One purpose of such preheating is to drive off any physically-adsorbed moisture from the inorganic substrate which blocks the inorganic substrate's pores and may interfere with the bromination step. Preferably, such heating is performed before bromination. When an optional treatment with a sulfur source is performed, preferably the inorganic substrate is heated before both the sulfur treatment and before bromination (after the sulfur treatment). The inorganic substrate can be used without drying, if desired, before either or both the sulfur treatment and bromination, although drying at least before the bromination step is preferred.

Preferably, after the contacting of the bromine source and the inorganic substrate, an additional step, removal of any weakly-held bromine species from the brominated sorbent, is performed. This can be accomplished by various methods, including applying vacuum to the vessel holding the brominated sorbent, purging the vessel with air or an inert gas, and/or heating the brominated sorbent to a temperature above the temperature at which the bromination was conducted. Preferably, this is accomplished by heating the brominated sorbent, normally to one or more temperatures of about 60° C. or more, preferably in the range of about 60° C. to about 150° C., more preferably in the range of about 100° C. to about 150° C.

The brominated inorganic sorbents of this invention typically contain about 0.1 to about 20 wt % bromine, preferably about 3 wt % to about 10 wt % bromine There is a possibility that some degree of bromine may evolve from the sorbent under some circumstances, especially when the bromine content of the brominated inorganic sorbent is above about 5 wt %. Greater degrees of bromination generally correlate with greater maximum mercury capacities for a particular sorbent. The optimum level of bromine-containing substance to combine with a substrate varies with the particular situation.

When the brominated inorganic sorbents have undergone optional treatment with a sulfur source, the sorbent has about 0.1 wt % to about 15 wt % sulfur, based on the weight of the sulfur-treated inorganic sorbent after contact with the sulfur source. Preferably the sulfur-treated inorganic sorbent has about 0.5 wt % to about 10 wt % sulfur, more preferably about 1 wt % to about 5 wt % sulfur, based on the weight of the sulfur-treated inorganic sorbent.

Preferably, the brominated inorganic sorbent is a brominated natural zeolite or a brominated uncalcined zeolite. More preferred brominated inorganic sorbents are brominated natural zeolites and brominated uncalcined zeolites having 0.5 to about 15 wt % bromine, more preferably about 3 wt % to about 10 wt % bromine. Also preferred as brominated inorganic sorbents are brominated natural chabazite, brominated natural clinoptilolite, and brominated ACZeo S-010; more preferred are brominated natural chabazite, brominated natural clinoptilolite, and brominated ACZeo S-010 having 0.5 to about 15 wt % bromine, more preferably about 3 wt % to about 10 wt % bromine.

In the practice of the present invention, the reduction of mercury emissions employs a brominated sorbent composition which is a brominated inorganic sorbent having about 0.5 wt % to about 20 wt % bromine therein, based on the total weight of the brominated inorganic sorbent. The brominated inorganic sorbent is formed from an inorganic substrate and a bromine source, which bromine source is elemental bromine and/or hydrogen bromide, with the provisos that when the bromine source is elemental bromine in a solution or in a carrier gas, the inorganic substrate is other than a ZSM-5 zeolite with an SiO₂:Al₂O₃ ratio of about 70:1 or greater; and when the bromine source is an aqueous solution of hydrogen bromide, the inorganic substrate is cement dust or an inorganic hydroxide, or the inorganic substrate has been treated with a sulfur source. As noted above, greater amounts of bromine can be incorporated into the inorganic substrate if desired. However, as the amount of bromine in the brominated sorbent increases, there is a greater possibility that some of the bromine may evolve from the brominated sorbent under some circumstances.

This invention provides flexible methods that can be applied to a number of combustion gas streams and a wide range of exhaust system equipment configurations. In these methods, i) a brominated sorbent is introduced into the combustion gas stream at one or more points upstream of a particulate collection device; and ii) the brominated sorbent is collected from the combustion gas stream, to reduce mercury emissions from an exhaust system which comprises at least a combustion gas stream and a particulate collection device. Generally, the brominated sorbent can be injected at any point upstream of a particulate collector. The brominated sorbent is introduced into a combustion gas stream, usually by injection, and is carried with the other particulates and gases to a particulate collection device, where the sorbent is collected. Typically, the sorbent is collected along with other particulates present in the combustion gas stream.

The brominated sorbent may be injected either before the gas is passed through a heat exchanger or air preheater, i.e., on the so-called “hot side” of a combustion gas exhaust system, or after the gas has passed through a heat exchanger or preheater, i.e., on the “cold side” of a combustion gas exhaust system. The preferred point(s) for injecting the brominated sorbent can vary, depending upon the configuration of the system. When injected, the brominated sorbent contacts a combustion gas stream, intimately mixes with the combustion gas stream, and is separated from the gas stream in a particulate collector, usually along with other particulates present in the combustion gas stream. Operating temperatures on the cold side are generally about 400° F. (204° C.) or less.

Within these parameters, it is recommended that the brominated sorbent be injected to maximize both the residence time of the sorbent in the system and the best distribution of the sorbent in the system, in order to provide the greatest opportunity for contact of the brominated sorbent and the mercury and/or mercury-containing compounds. Due to the wide variation in plant configurations, the optimum injection point(s) will vary from plant to plant.

The brominated sorbents are typically injected at a rate of about 0.5 to about 15 lb/MMacf (8×10⁻⁶ to 240×10⁻⁶ kg/m³). Preferred injection rates are about 1 to about 10 lb/MMacf (16×10⁻⁶ to 160×10⁻⁶ kg/m³); more preferred are injection rates of about 2 to about 5 lb/MMacf (32×10⁻⁶ to 80×10⁻⁶ kg/m³), though it is understood that the preferred injection rate varies with the kinetics of reaction for mercury species with the sorbent, the mercury capacity of the sorbent, the relevant mercury emission limit, and the particular system configuration.

Optionally, other agents, such as conditioning agents, can be injected if needed or desired. Preferably, no agents other than the brominated sorbent are added. It is preferred to practice the invention in the absence of conditioning agents.

Without wishing to be bound by theory, it is believed that the brominated sorbent comes into contact with mercury and/or mercury-containing compounds, which are then absorbed by the brominated sorbent. The brominated sorbent travels from the injection point with the combustion gas stream and can be collected, along with other particulates, in a particulate collection device placed in the combustion gas stream.

The following examples are presented for purposes of illustration, and are not intended to impose limitations on the scope of this invention.

In all of the following Examples, the brominated sorbents were evaluated for mercury removal in a pilot duct injection system with a simulated flue gas. The 50-acfm (85 m³/h) pilot scale test system included a natural gas burner unit to generate the hot flue (combustion) gas, a humidification drum to add moisture to the gas, an elemental mercury spiking subsystem with elemental mercury permeation tubes, a flue gas spiking subsystem with mass flow controllers for SO₂, NOₓ, and HCl, a small sorbent feeder and eductor with compressed air to carry the sorbent to the duct, insulated duct thermocouples, an electrostatic precipitator (ESP) with an effective specific collection area (SCA) of about 500 ft²/Kacfm (27.3 m²/1000 m³/h), a back-up fabric filter, a safety filter, an orifice plate to measure flow, and a variable-speed induced draft (ID) fan.

The simulated flue gas contained 12% O₂, 4% CO₂, and 8% H₂O, with the balance of the gas being N₂. Elemental mercury was introduced into the simulated flue gas from permeation tubes, and SO₂, NOₓ, and HCl were introduced into the simulated flue gas from lecture bottles (gas bottles). In the simulated flue gas, the concentrations of added substances were about 10 μg/Nm³ Hg⁰, 800 ppm SO₂, 400 ppm NOₓ, and 5 ppm HCl. The flue gas temperature at the injection point was about 205° C., and at the electrostatic precipitator the gas temperature was about 150° C.

Samples were injected at various rates into the hot gas with a ductwork residence time of about 2 seconds before reaching the electrostatic precipitator. In each test run, a few grams (usually 2 grams) of the sample being evaluated was injected into the simulated flue gas at 400±10° F. (204±˜2° C.); the brominated sorbent remained in-flight in the simulated flue gas for about 2 seconds, and then the brominated sorbent was collected by the electrostatic precipitator.

Each test run normally lasted for about 40 minutes. Mercury levels in flue gas were continuously measured with an on-line gas-phase elemental mercury analyzer (cold vapor atomic absorption (CVAA) spectrometer, model RA-915+, Ohio Lumex Company). Mercury removal rates were calculated based on the mercury concentrations during and before sorbent injection.

The average mercury removal rate was the difference of the average baseline Hg concentration before injection and the average Hg concentration during sorbent injection, relative to the baseline Hg concentration, and is expressed as a percentage. One way to calculate the average mercury removal rate is by the following formula:

$$Avg . Hg removal rate = \frac{[ avg . Hg conc . ( pre \text{-} injection ) - avg . Hg . conc . ( injection ) ]}{average Hg conc . ( pre \text{-} injection )} \times 100$$

The equilibrium mercury removal rate was calculated in the same manner as the average mercury removal rate, but replacing the average Hg concentration during the injection period with the steady-state mercury concentration during the injection period.

### Example 1

Samples of natural chabazite and an uncalcined sample of a commercial oil refining catalyst (ACZeo S-010, an uncalcined catalyst precursor of ACZeo S 100, a SAPO zeolite; internal product of Albemarle Corporation) were dried at 100° C.; for the milled chabazite sample, drying was performed after milling.

The unmilled chabazite and the ACZeo S-010 were treated with an amount of bromine (Br₂). Each sample was weighed into a glass bottle. For each sample, a known amount of liquid bromine was introduced into a smaller bottle. The smaller bottle containing the liquid bromine was set upright in the bottle with the inorganic substrate. The larger bottle was sealed; the smaller bottle of liquid bromine was left open inside the larger bottle at room temperature. The bottle setups were allowed to remain undisturbed overnight. After bromination, both samples were a uniform off-white to tan color. After the bromination was complete, both of the brominated sorbents were heated to 100° C. for an hour to remove any excess (unadsorbed) bromine that was present.

The brominated samples just formed were evaluated for mercury removal in the above-described pilot duct injection system with an above-described simulated flue gas. Two samples of unbrominated chabazite were run for comparison. Measurements to determine the average mercury removal and equilibrium mercury removal were as described above. Results of these mercury removal test runs are summarized in Table 1; Runs A and C are comparative.

TABLE 1

| | Inorganic | | | | | | Avg. Hg | Equil. Hg |
|---|---|---|---|---|---|---|---|---|
| | substrate or test | Br | Amount | | Heat | | removal | removal |
| Run | sample | source | Br | | treatment | Injection rate | rate | rate |
| A | unmilled | — | 0 | | — | 3.96 lb/MMacf | 4% | 5% |
| | chabazite | | | | | (63 × 10⁻⁶ kg/m³) | | |
| B | unmilled | Br₂ | 0.84 | wt % | 100° C., 1 hr. | 3.63 lb/MMacf | 8% | 12% |
| | chabazite | | | | | (58 × 10⁻⁶ kg/m³) | | |
| C | ACZeo S-010¹ | — | 0 | | — | 4.32 lb/MMacf | 4% | 6% |
| | | | | | | (69 × 10⁻⁶ kg/m3) | | |
| D | ACZeo S-010¹ | Br₂ | 5 | wt % | 100° C., 1 hr. | 2.57 lb/MMacf | 50% | 51% |
| | | | | | | (41 × 10⁻⁶ kg/m³) | | |

¹An uncalcined precursor of ACZeo S100, a SAPO zeolite; product of Albemarle Corporation.

### Example 2

Samples of natural chabazite (unmilled) and an uncalcined sample of a commercial oil refining catalyst (ACZeo S-010, as described above; internal product of Albemarle Corporation) were dried at 100° C. One of the chabazite samples and the ACZeo S-010 were each mixed and heated with elemental sulfur at temperatures greater than 115° C. for an hour prior to treatment with bromine. The samples were then cooled to room temperature. Portions of these two samples (containing sulfur but not brominated) were evaluated for mercury removal in the above-described pilot duct injection system with an above-described simulated flue gas. Measurements to determine the average mercury removal and equilibrium mercury removal were as described above, and the results of these mercury removal test runs are summarized in Table 2 as the comparative runs.

Another chabazite sample was treated with sulfur by spraying the chabazite (5 g) with an aqueous solution of sodium thiosulfate (5 g, 3.6 wt %). This sulfur-treated chabazite was air-dried overnight in a fume hood, and was then dried in an oven at 110° C. for 2 hours. The dried sulfur-treated chabazite was a uniform yellow-orange color. Separately, another chabazite sample was blended at room temperature with enough solid sodium thiosulfate to provide 2 wt % of sulfur by stirring the two powders together for 2 to 5 minutes. The blended mixture had the same color as the chabazite before treatment.

Two of the sulfur-treated chabazite samples were brominated with liquid bromine at room temperature (see Table 2 below). For the samples treated with liquid bromine, a pre-measured amount of liquid bromine was placed in a dropping funnel and the liquid bromine was added dropwise to the sulfur-treated chabazite sample. After stirring for a few minutes, the brown color from the bromine disappeared, leaving a solid having the same color as the sulfur-treated chabazite. The bromine-treated samples were left open to the atmosphere in a fume hood for one hour.

The two samples that had been treated with elemental sulfur were treated with gaseous bromine (Br₂). Each substrate was weighed into a glass bottle, and a known amount of gaseous bromine was fed into each bottle at room temperature. The bottles were allowed to remain undisturbed overnight. The sulfur-treated, brominated ACZeo S-010 and chabazite samples were a uniform brown and tan color, respectively.

The sulfur source and bromine source used with each inorganic substrate is listed in Table 2 below. The amount of sulfur in the sulfur-containing brominated sorbent in each run is listed in Table 2 below, and is reported as wt % relative to the total weight of the inorganic substrate and the sulfur source (without the weight of the bromine source). It was assumed that all of the sulfur from the sulfur source became incorporated into the inorganic substrate. The amount of bromine in the brominated sorbent in each run is listed in Table 2 below, and is reported as wt % relative to the total weight of the (inorganic substrate+sulfur source+bromine source) mixture; it was assumed that all of the bromine from the bromine source became incorporated into the product sorbent.

After the bromination was complete, all of the brominated sorbents were heated to 100° C. for an hour to remove any excess (unadsorbed) bromine that was present. The brominated samples just formed were evaluated for mercury removal in the above-described pilot duct injection system with an above-described simulated flue gas. Measurements to determine the average mercury removal and equilibrium mercury removal were as described above. The inventive runs are F, G, H, and I. Results of these mercury removal test runs are summarized in Table 2.

TABLE 2

| Run | Comparative | F | G | H | I | Comparative |
|---|---|---|---|---|---|---|
| Inorganic | unmilled | unmilled | unmilled | unmilled | ACZeo S- | ACZeo S- |
| substrate | chabazite | chabazite | chabazite | chabazite | 010¹ | 010¹ |
| S source | elemental S | elemental S | Na₂S₂O₃ | Na₂S₂O₃ | elemental S | elemental S |
| | | | (aq., 3.6 wt | (s) | | |
| | | | %) | | | |
| Amount S | 5 wt % | 5 wt % | 2 wt % | 2 wt % | 5 wt % | 5 wt % |
| Br source | Br₂(g) | Br₂(g) | Br₂(l) | Br₂(l) | Br₂(g) | Br₂(g) |
| Amount | 0 wt % | 10 wt % | 10 wt % | 10 wt % | 8 wt % | 0 wt % |
| Br | | | | | | |
| Injection | 4.82 lb/ | 2.39 lb/ | 2.40 lb/ | 2.43 lb/ | 2.39 lb/ | 3.90 lb/ |
| rate | MMacf | MMacf | MMacf | MMacf | MMacf | MMacf |
| | (77 × 10⁻⁶ kg/m³) | (38 × 10⁻⁶ kg/m³) | (38 × 10⁻⁶ kg/m³) | (39 × 10⁻⁶ kg/m³) | (38 × 10⁻⁶ kg/m³) | (62 × 10⁻⁶ kg/m³) |
| Avg. Hg | 4% | 73% | 59% | 57% | 76% | 7% |
| removal | | | | | | |
| rate | | | | | | |
| Equil. Hg | 7% | 78% | 63% | 56% | 77% | 10% |
| removal | | | | | | |
| rate | | | | | | |

¹An uncalcined precursor of ACZeo S100, a SAPO zeolite; product of Albemarle Corporation.

Further embodiments of the invention include, without limitation:
a) A brominated sorbent composition which is a brominated inorganic sorbent having about 0.5 wt % to about 15 wt % bromine therein, based on the total weight of the brominated inorganic sorbent, wherein said brominated inorganic sorbent is formed from an inorganic substrate and a bromine source, which bromine source is
elemental bromine, with the proviso that
   when the bromine source is elemental bromine in solution or in a carrier gas, the inorganic substrate is other than a ZSM-5 zeolite with an SiO₂:Al₂O₃ ratio of about 70:1 or greater; and/or
hydrogen bromide, with the proviso that
   when the hydrogen bromide is an aqueous solution of hydrogen bromide, either the inorganic substrate or the brominated inorganic sorbent has been treated with a sulfur source, or the inorganic substrate is cement dust or an inorganic hydroxide, and
wherein said brominated inorganic sorbent further comprises about 0.5 wt % to about 10 wt % sulfur, based on the weight of the inorganic substrate before it is brominated.
b) A brominated sorbent composition which is a brominated inorganic sorbent having about 0.5 wt % to about 15 wt % bromine therein, based on the total weight of the brominated inorganic sorbent, wherein said brominated inorganic sorbent is formed from an inorganic substrate and a bromine source, which bromine source is
elemental bromine, with the proviso that
   when the bromine source is elemental bromine in solution or in a carrier gas, the inorganic substrate is other than a ZSM-5 zeolite with an SiO₂:Al₂O₃ ratio of about 70:1 or greater; and/or
hydrogen bromide, with the proviso that
   when the hydrogen bromide is an aqueous solution of hydrogen bromide, either the inorganic substrate or the brominated inorganic sorbent has been treated with a sulfur source, or the inorganic substrate is cement dust or an inorganic hydroxide.
c) A brominated sorbent composition as in b) wherein said brominated inorganic sorbent further comprises about 0.5 wt % to about 10 wt % sulfur, based on the weight of the inorganic substrate before it is brominated.
d) A brominated sorbent composition as in c) wherein said sulfur source is elemental sulfur or a salt of sulfur-containing ion.
e) A brominated sorbent composition as in any of a)-d) wherein said brominated inorganic sorbent is a brominated natural zeolite or a brominated uncalcined zeolite.
f) A brominated sorbent composition as in any of a)-e) wherein said brominated inorganic sorbent is brominated natural chabazite, brominated natural clinoptilolite, or brominated ACZeo S-010.
g) A brominated sorbent composition as in any of a)-f) wherein the brominated inorganic sorbent has about 3 wt % to about 10 wt % bromine
h) A brominated sorbent composition as in any of a)-g) wherein said brominated inorganic sorbent further comprises about 1 wt % to about 5 wt % sulfur, based on the weight of the inorganic substrate before it is brominated.
i) A brominated sorbent composition as in h) wherein said sulfur source is elemental sulfur or a salt of sulfur-containing ion.
j) A brominated inorganic sorbent having about 0.5 wt % to about 20 wt % bromine therein, based on the total weight of the brominated inorganic sorbent, said brominated inorganic sorbent prepared by
contacting an inorganic substrate and a bromine source, which bromine source is elemental bromine and/or hydrogen bromide, and
optionally contacting a sulfur source and the inorganic substrate, the sulfur source and the inorganic substrate being contacted before or during the contacting of the inorganic substrate and the bromine source,
with the provisos that
   when the bromine source is elemental bromine in solution or in a carrier gas, the inorganic substrate is other than a ZSM-5 zeolite with an SiO₂:Al₂O₃ ratio of about 70:1 or greater; and
   when the bromine source is an aqueous solution of hydrogen bromide, either the inorganic substrate or the brominated inorganic sorbent has been treated with a sulfur source, or the inorganic substrate is cement dust or an inorganic hydroxide.
k) A brominated sorbent composition as in j) wherein said brominated inorganic sorbent further comprises about 0.1 wt % to about 15 wt % sulfur, based on the weight of the inorganic sorbent before it is brominated.
l) A brominated sorbent composition as in j) wherein said brominated inorganic sorbent further comprises about 0.5 wt % to about 10 wt % sulfur, based on the weight of the inorganic sorbent before it is brominated.
m) A brominated sorbent composition as in k) or l) wherein said sulfur source is elemental sulfur or a salt of sulfur-containing ion.
n) A brominated sorbent composition as in any of j)-l) wherein the brominated inorganic sorbent has about 0.5 wt % to about 15 wt % bromine.
o) A brominated sorbent composition as in any of j)-l) wherein the brominated inorganic sorbent has about 3 wt % to about 10 wt % bromine
p) A method for preparing a brominated inorganic sorbent, which method comprises
contacting an inorganic substrate and a bromine source, which bromine source is elemental bromine and/or hydrogen bromide, and
optionally contacting a sulfur source and the inorganic substrate, the sulfur source and the substrate being contacted before or during the contacting of the inorganic substrate and the bromine source,
to form a brominated inorganic sorbent, with the provisos that
   when the bromine source is elemental bromine in solution or in a carrier gas, the inorganic substrate is other than a ZSM-5 zeolite with an SiO₂:Al₂O₃ ratio of about 70:1 or greater; and
   when the bromine source is an aqueous solution of hydrogen bromide, either the inorganic substrate or the brominated inorganic sorbent has been treated with a sulfur source, or the inorganic substrate is cement dust or an inorganic hydroxide.
q) A method as in p) wherein the inorganic substrate is at a temperature at or above about 150° C. during the contacting of the inorganic substrate and the bromine source.
r) A method as in p) wherein the contacting of the inorganic substrate and the bromine source is conducted at one or more temperatures in the range of about 65° C. to about 175° C.
s) A method as in any of p)-r) wherein the inorganic substrate begins the contacting of the inorganic substrate and the bromine source at ambient temperature.
t) A method as in any of p)-s) wherein the inorganic substrate is preheated prior to contact with the bromine source.
u) A method for preparing a brominated inorganic sorbent, which method comprises
contacting an inorganic substrate and a bromine source, which bromine source is elemental bromine and/or hydrogen bromide, wherein either the inorganic substrate begins at ambient temperature, or the inorganic substrate is preheated prior to contact with the bromine source, and
optionally contacting a sulfur source and the inorganic substrate, the sulfur source and the inorganic substrate being contacted before or during the contacting of the inorganic substrate and the bromine source,
to form a brominated inorganic sorbent, with the provisos that
   when the bromine source is elemental bromine in solution or in gaseous form in a carrier gas, the inorganic substrate is other than a ZSM-5 zeolite with an SiO₂:Al₂O₃ ratio of about 70:1 or greater; and
   when the hydrogen bromide is an aqueous solution of hydrogen bromide, either the inorganic substrate or the brominated inorganic sorbent has been treated with a sulfur source, or the inorganic substrate is cement dust or an inorganic hydroxide.
v) A method as in any of p)-u) wherein the bromine source is elemental bromine
w) A method as v) wherein the elemental bromine is in gaseous form.
x) A method as in any of p)-u) wherein said bromine source is hydrogen bromide.
y) A method as in any of p)-x) further comprising the step of removing weakly-held bromine species from the brominated inorganic sorbent.
z) A method as in any of p)-y) wherein said inorganic substrate is contacted with a sulfur source, and said sulfur source is elemental sulfur or a salt of sulfur-containing ion.
aa) A method as in z) wherein said sulfur source is elemental sulfur or a thiosulfate compound.
bb) A method as in any of p)-aa) wherein the brominated inorganic sorbent prepared by the method has about 0.5 wt % to about 20 wt % bromine, based on the total weight of the brominated inorganic sorbent.
cc) A method as in any of p)-aa) wherein the brominated inorganic sorbent has about 0.5 wt % to about 15 wt % bromine, based on the total weight of the brominated inorganic sorbent.
dd) A method as in any of p)-aa) wherein the brominated inorganic sorbent prepared by the method has about 3 wt % to about 10 wt % bromine, based on the total weight of the brominated inorganic sorbent.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A brominated sorbent composition which is a brominated inorganic sorbent having about 0.5 wt % to about 20 wt % bromine therein, based on the total weight of the brominated inorganic sorbent, wherein said brominated inorganic sorbent is formed from an inorganic substrate and a bromine source, which bromine source is
elemental bromine, with the proviso that
when the elemental bromine is in solution or in a carrier gas, the inorganic substrate is other than a ZSM-5 zeolite with an SiO₂:Al₂O₃ ratio of about 70:1 or greater; and/or
hydrogen bromide, with the proviso that
when the hydrogen bromide is an aqueous solution of hydrogen bromide, either the inorganic substrate or the brominated inorganic sorbent has been treated with a sulfur source, or the inorganic substrate is cement dust or an inorganic hydroxide.

2. A composition as in claim 1 wherein said brominated inorganic sorbent is a brominated natural zeolite or a brominated uncalcined zeolite.

3. A composition as in claim 1 wherein said brominated inorganic sorbent is brominated natural chabazite, brominated natural clinoptilolite, or brominated ACZeo S-010.

4. A composition as in claim 1 wherein said brominated inorganic sorbent further comprises about 0.1 wt % to about 15 wt % sulfur, based on the weight of the inorganic sorbent before it is brominated.

5. A composition as in claim 4 wherein said sulfur source is elemental sulfur or a salt of sulfur-containing ion.

6. A method, which comprises
contacting an inorganic substrate and a bromine source, which bromine source is elemental bromine and/or hydrogen bromide,
optionally contacting a sulfur source and said inorganic substrate, said sulfur source and said inorganic substrate being contacted before or during the contacting of the inorganic substrate and the bromine source,
to form a brominated inorganic sorbent, with the provisos that
when the bromine source is elemental bromine in solution or in a carrier gas, the inorganic substrate is other than a ZSM-5 zeolite with an SiO₂:Al₂O₃ ratio of about 70:1 or greater; and
when the bromine source is an aqueous solution of hydrogen bromide, either the inorganic substrate or the brominated inorganic sorbent has been treated with a sulfur source, or the inorganic substrate is cement dust or an inorganic hydroxide.

7. A method as in claim 6 further comprising
i) introducing a brominated inorganic sorbent prepared in claim 6 into said combustion gas stream at one or more points upstream of a particulate collection device; and
ii) collecting the brominated inorganic sorbent from the combustion gas stream.

8. A method for reducing mercury emissions from an exhaust system which comprises at least a combustion gas stream and a particulate collection device, which method comprises
i) introducing a brominated sorbent into said combustion gas stream at one or more points upstream of a particulate collection device; and
ii) collecting the brominated sorbent from the combustion gas stream,
wherein said brominated sorbent is a brominated inorganic sorbent having about 0.5 wt % to about 20 wt % bromine therein, based on the total weight of the brominated inorganic sorbent, wherein said brominated inorganic sorbent is formed from an inorganic substrate and a bromine source, which bromine source is
elemental bromine, with the proviso that
when the elemental bromine is in solution or in a carrier gas, the inorganic substrate is other than a ZSM-5 zeolite with an SiO₂:Al₂O₃ ratio of about 70:1 or greater; and/or
hydrogen bromide, with the proviso that
when the hydrogen bromide is an aqueous solution of hydrogen bromide, either the inorganic substrate or the brominated inorganic sorbent has been treated with a sulfur source, or the inorganic substrate is cement dust or an inorganic hydroxide.

9. A method as in claim 6 wherein said inorganic substrate is a natural zeolite or an uncalcined zeolite.

10. A method as in claim 6 wherein said inorganic substrate is natural chabazite, brominated natural clinoptilolite, or ACZeo S-010.

11. A method as in claim 6 wherein said bromine source is elemental bromine.

12. A method as in claim 11 wherein the elemental bromine is in gaseous form or in liquid form.

13. (canceled)

14. A method as in claim 6 wherein said bromine source is hydrogen bromide.

15. A method as in claim 14 wherein the hydrogen bromide is in gaseous form or is a solution of hydrogen bromide.

16. (canceled)

17. A method as in claim 6 wherein said inorganic substrate is contacted with a sulfur source, and wherein said sulfur source is elemental sulfur or a salt of sulfur-containing ion.

18. (canceled)

19. A method as in claim 8 wherein said brominated inorganic sorbent is a brominated natural zeolite or a brominated uncalcined zeolite.

20. A method as in claim 8 wherein said brominated inorganic sorbent is brominated natural chabazite, brominated natural clinoptilolite, or brominated ACZeo S-010.

21. A method as in claim 8 wherein the brominated sorbent is injected into the combustion gas stream before the gas stream before passes through a heat exchanger, or after the gas stream passes through a heat exchanger.

22. (canceled)

23. A method as in claim 8 wherein the method is carried out in the absence of conditioning agents.

24. (canceled)
